(19) United States
(12) Patent Application Publication
(10) Pub. No.: US 2006/0086923 A1
(43) Pub. Date: Apr. 27, 2006

(54) Rotary valve and control system

(75) Inventors: John R. Shank, Mendham, NJ (US); John E. Albright, Hackettstown, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Marotta Controls, Inc., Montville, NJ (US)

(21) Appl. No.: 11/233,655

(22) Filed: Sep. 23, 2005

Related U.S. Application Data
(60) Provisional application No. 60/617,622, filed on Oct. 8, 2004.

(51) Int. Cl. F16K 25/00

(52) U.S. Cl. 251/198

(57) ABSTRACT

A valve assembly includes a first gate having at least one opening and a second gate having at least one opening, the second gate being spaced from the first gate. The valve assembly has first and second discs disposed between the first and second gates, each disc having at least one opening, whereby the discs are coupled together for simultaneously rotating between a valve open and a valve closed position. The assembly also includes a biasing element disposed between the first and second discs for normally urging the discs away from one another and toward opposing inner faces of the first and second gates.

### CROSS-REFERENCE TO RELATED APPLICATIONS

The present application claims benefit of U.S. Provisional Application Ser. No. 60/617,622, filed Oct. 8, 2004, the disclosure of which is hereby incorporated by reference herein.

### BACKGROUND OF THE INVENTION

The present invention is related to fluid control systems and is more particularly related to valves for controlling fluids.

There has been a significant level of development in valves for controlling fluids. For example, U.S. Pat. No. 4,516,606 to Worley discloses a double disc valve having a first fixed plate 16 with orifice openings 28, and a second adjustable plate 22 with complementary orifice openings 30. The adjustable plate 22 is connected to an adjustment lug 32, which extends radially outward through an aperture 36 of the exterior housing 34. The adjustment lug 32 is threadably engaged with a hand wheel means 38 to suitably position the adjustable plate 22 into an open or closed position. The valve is in an open position when the orifice openings of the adjustable plate 22 align with the orifice openings of the fixed plate 16. Alternatively, when the orifice openings of the adjustable plate 22 do not align with the orifice openings 28 of the fixed plate 16, the valve is closed. Worley further teaches that hydraulic rams or electric motors can be used to manipulate movement of the adjustable plate 22.

U.S. Pat. No. 5,386,966 to Gosch discloses a rotary ceramic slide valve for controlling the flow of molten material from a discharge opening of a holding vessel into an inlet of a rotatable casting mold. The valve consists of three plates: a fixed inflow plate 31, a rotatable outflow plate 11, and a rotatable intermediate plate 21 disposed between the inflow and outflow plates. Each of the plates have openings therethrough, such that when the openings of the outflow plate 11 and intermediate plate 21 align with the openings of the inflow plate 31, an axial flow passage through the valve is formed. Alternatively, if at least one of the openings of the outflow plate 11 and intermediate plate 21 are not aligned with the openings of inflow plate 31, no flow is permitted through the valve.

U.S. Pat. Nos. 4,304,261 and 4,499,919 to Forester generally discloses a valve body having two valve discs 25 with orifice openings, one valve disc being kept in use, and the other being incorporated as a backup valve disc. A seat assembly 40 is pushed upwards against the valve body 12 and disc 25 by springs 39 to form a seal in the passageway that will prevent leakage along the axial path through the valve disc. Ball bearings 30 are placed into a groove located on the disc 25, and act as teeth on a gear. A piston rod 5 has a number of grooves 56 that partially engage or extend around the ball bearings 30. When the piston rod 5 is rotated, it moves the ball bearings 30, which, in turn causes rotation of the disc 25.

U.S. Pat. No. 3,478,771 to Johnson discloses a valve having a pair of end sections forming opposed seat faces 20, 24 and a gate 40 comprising a pair of circular discs 42,44 separated by springs. The springs produce pressure on the discs 42, 44 to sealingly engage the oppositely detected rims 53 of the discs 42,44 against seat areas 57,58 formed on faces 20, 24 and form a metal to metal seal around the fluid ports formed by the bores of members 12 and 14 in valve closed position. The gate can be raised or lowered to permit the flow of fluids through the passageway, and the edges 50 of the gate scrape deposits and dirt from seat faces 20,24 when the gate is moved between an open and closed position.

U.S. Pat. No. 4,706,934 to Brown discloses a gate valve having valve seats 26, and a wedge 60 coupled to two valve gates 70 located on each of its sides. When the valve is in its closed position, a seal is formed between the valve seats 26 and the two valve gates 70. The valve is moved to an open position when the wedge 60 and gate valves 70 are moved in a direction perpendicular to the flow axis.

U.S. Pat. No. 4,664,139 to Pfeiffer discloses a valve for controlling particulate solids flow. The valve has a circular passageway and a valve slide 24 having an ovoid orifice opening. The slide can be positioned so that the ovoid opening is aligned with the passageway so as to permit the free flow of fluid through the passageway. Alternatively, when the ovoid opening is not aligned with the passageway, fluids are prevented from flowing through the passageway. Several intermediate positions are also available, wherein only a portion of the ovoid opening aligns with the passageway. This provides the user with a greater amount of control over the flow of fluid through the passageway.

U.S. Pat. No. 4,431,028 to Hendrick (see also U.S. Pat. No. 4,360,040 to Cove et al.), discloses a multiple orifice flow control valve having a fixed disc 13 with orifice openings and a rotatable disc 13 with orifice openings mounted in face-to-face engagement in the valve body. The rotatable disc 12 rotates relative to the fixed disc for superimposing its orifices in various degrees of overlap or alignment with the orifices of the fixed disc. The rotatable disc 12 is mounted in an annular ring 28, which surrounds the circumference of the rotatable disc 12. To effect movement of the rotatable disc 12, an operator member 30 is mounted in the valve body. The operator member 30 has tines 34 that engage slots in the annular ring 28, which in turn holds the upstream disc. When the valve stem is rotated, the tines 34 engaged in the slots cause rotation of the annular ring 28, which in turn rotates the rotatable disc 12.

U.S. Pat. No. 4,372,531 to Rollins et al. discloses a ceramic gate valve including a ceramic gate 44, ceramic seats 45,46 located on either side of the ceramic gate, and ceramic springs 30,32. The ceramic springs 30,32 are located on either side of the ceramic seats 45,46, and urge the ceramic seats 45,46 inwardly toward and into engagement with the ceramic gate 44 to effect a seal therebetween. The ceramic gate 44 can be incrementally raised or lowered to regulate the flow of fluid through the passageway 25 of the ceramic gate valve.

U.S. Pat. No. 3,614,061 to Fitzpatrick discloses a gate valve having a ceramic gate 18 and ceramic seats 42, 50 disposed on opposite sides of the gate member 18 that are in constant engagement with gate member 18. The ceramic gate 18 can be incrementally raised or lowered to regulate the flow of fluid through the valve passageway.

As it designs the next generation of ships and submarines, a prime objective of the United States Navy is to reduce crew size. For example, on its new DD(X) destroyer, the United States Navy has a goal of reducing crew size from 385 to 90. The efficient operation of ships having smaller crews will require manual devices to be replaced with automatic devices. For example, manual valves in current systems must be replaced with automatic valves in the new ships and submarines. These automatic valves must also be capable of rapidly diagnosing malfunctions and providing the crew with feedback information necessary to correct problems in the system.

Commonly assigned U.S. Provisional Application No. 60/376,094 entitled, “In-Line Valve and Control System,” the disclosure of which is hereby incorporated by reference herein, teaches a new valve design to be used in chilled water systems of United States Navy ships and submarines. The new valve design disclosed in the '094 provisional application shows a valve that operates on demand to allow or prevent flow through the portion of the chilled water system it controls. The valve allows bi-directional flow through the valve, which provides an operator maximum flexibility to reroute flow to the most critical equipment in the event of system malfunction or battle damage. Depending upon the needs of the system, the valve is able to open and close valves at varying speeds for modulating fluid flow through the valve. The valve disclosed in the '094 application also provides for controlling the flow of sea water and dirty liquids, to mechanically contour the opening and closing flow profiles and to fit into a much more compact envelope.

In spite of the above advances, further improvements in valves for controlling fluids are desired.

### SUMMARY OF THE INVENTION

In certain preferred embodiments of the present invention, a valve assembly includes a first gate having at least one opening, and a second gate having at least one opening, the second gate being spaced from the first gate. The assembly also preferably includes first and second discs disposed between the first and second gates, each disc having at least one opening, wherein the discs are coupled together for simultaneously rotating between a valve open and a valve closed position. The valve assembly may also desirably include a biasing element disposed between the first and second discs for normally urging the discs away from one another and toward opposing inner faces of the first and second gates.

In certain preferred embodiments, the first and second gates are stationary and the first and second discs are rotatable relative to the stationary gates. At least one opening of the first gate is desirably in at least partial alignment with the at least one opening of the second gate. The assembly may also include a center housing at least partially surrounding the rotatable discs, whereby the first and second gates are connected with the center housing.

Each gate preferably includes a sealing seat surrounding the openings of the gates, the sealing seats being raised relative to the inner faces of said gates. The sealing seats may be made of ceramic. The first and second gates and the rotatable discs may also be made of ceramic.

In operation, the openings of the discs are at least partially aligned with the openings of the gates when the discs are in the valve open position. In contract, the openings of the discs are not in alignment with the openings of the gates when the discs are in the valve closed position.

The valve assembly also preferably includes a gear ring coupled with the discs, whereby rotation of the gear ring drives rotation of the rotatable discs. The assembly may also include at least one key slot and at least one key projection for coupling the gear ring and the rotatable discs, whereby the discs are free to move axially relative to the gear ring.

The valve assembly may also include a first flange coupled with the first gate on a first side of the valve assembly and a second flange coupled with the second gate on a second side of the valve assembly. Each flange desirably includes at least one opening in communication with the openings of the respective gates. Each flange may also include a support web adapted to engage one of the gates for providing support for the gate. Each flange also desirably has an external coupling interface for coupling piping to the valve assembly.

In certain preferred embodiments of the present invention, the assembly includes an actuator coupled with the first and second rotatable discs for rotating the discs between the valve open and the valve closed positions. The actuator may include a gear attached to the first and second rotatable discs and a movable drive shaft coupled with the gear. The gear preferably has gear teeth and the drive shaft desirably has projections that mesh with the gear teeth. The drive shaft may be rotatable and have threads.

In certain preferred embodiments, the inner faces of the rotatable discs have blind vias and ends of the springs are positioned in the blind vias. The springs may be helical springs.

In other preferred embodiments of the present invention, a valve assembly includes a center housing having a central opening extending from a first side to a second side of the center housing, a first gate secured to the first side of the center housing, and a second gate secured to the second side of the center housing. The assembly also desirably includes a pair of rotatable discs disposed in the center housing, each disc having at least one opening extending therethrough, and a biasing element for urging the rotatable discs away from one another and toward the respective first and second gates. The assembly also preferably has an actuator coupled with the rotatable discs for selectively rotating the discs.

The actuator may include a ring gear coupled with the rotating discs and a worm gear coupled with the ring gear. The ring gear may have at least one key slot and the rotatable discs may have at least one projection that fits within the at least one key slot. In other preferred embodiments, the ring gear has at least one projection and the rotatable discs have at least one key slot that receives the at least one projection of the ring gear.

The rotary valve of the present invention incorporates all of the features listed above and outlined in U.S. Provisional Application No. 60/376,094. However, it also has the additional capabilities to control the flow of seawater & dirty liquids, to mechanically contour the opening and closing flow profiles, and to fit into a much more compact envelope.

In certain preferred embodiments, the operation of the valve is controlled by a motor/worm gear drive assembly that transmits force to a gear, which, in turn, rotates the two rotatable discs. The two rotatable discs are maintained against the stationary ceramic gate plates by springs. Alignment of the two holes in the two center rotatable discs with the stationary ceramic gate plates allows flow through the valve. 90-degree rotation of the rotatable discs from this point blocks flow through the valve. Since the valve is preferably designed for bi-directional flow, two pairs of stationary gate plates and rotatable discs are required. If only unidirectional flow is required, one pair could be eliminated. In preferred embodiments, regardless of flow direction, the downstream pair always provides sealing.

The present invention may also provide ceramic on ceramic shear-seal seating. Many conventional valves require soft seating members to provide leak-tight valve shut-off. Soft seating is inherently subject to damage from contaminants in dirty liquid applications and to relatively short life due to wear and degradation of the soft seating materials. In addition, many soft seating materials tend to grow to mating metal parts when closed for long periods of time. This phenomenon increases the required force to open the valve on the first operation after a long period in the closed state. Manufacturers will frequently oversize actuators to provide the required force to break through this growth. If the soft seating material sufficiently attaches to the mating metal parts, it may actually be torn apart on opening thereby compromising the leak-tight capability of the valve. These problems are eliminated by the present invention, which, in certain preferred embodiments, provides ceramic on ceramic shear-seal seating.

The present invention also solves problems associated with biofouling, which is the undesirable accumulation of microorganisms, plants and animals found in seawater. A typical sequence of biofouling would be initiated by a build-up of microfoulers such as sticky bacteria biofilms colonizing on internal valve surfaces followed by a continuing build-up of larger macrofoulers such as slime, barnacles, seaweeds and limpets. Biofouling can impede the movement of internal parts of a typical valve, can prevent tight seating of a typical valve because of the tendency for biofouling build-up to form unevenly on seating surfaces, and can even build up to the point of totally blocking flow through valves and associated piping. The surfaces of the rotary valve of the present invention in contact with seawater will preferably be constructed of ceramic and copper-alloy materials that do not allow the microfoulers to gain a foothold on its internal surfaces. The shear-seal seating feature provided in the present application will generally push aside or cut through macrofoulers within the seawater that might otherwise impede valve closing. Additionally, the rotary ceramic valve of the present invention has no “dead pockets” which may allow seawater stagnation and promote the growth of biofoulers.

In certain preferred embodiments, the valve incorporates a 4″ ESEOD, which is able to fit within the 12″ face-to-face requirement specified in ANSI B16.2. Accordingly, the valve of the present invention is directly interchangeable with standard butterfly and other short face-to-face valves that are commonly used in current United states Navy applications. In other preferred embodiments, the valve sizes may be proportionally sized and may also be in compliance with the same ANSI B16.2 requirements.

The rotary valve assembly of the present invention also provides for flow profile contouring. This is preferably accomplished by substituting ceramic rotary discs and/or stationary ceramic gate plates with varying configurations of flow passage openings. This enables the system to create a variety of flow profiles. This feature may provide the valve user with more precise modulation profiles with less sophisticated positioning controls.

The present invention also preferably provides a unique gear/disc arrangement whereby the two center rotatable discs float in the gear that drives the rotatable discs. This feature allows the actuation force to be transferred to the rotatable discs but does not allow pressure load on the discs to transfer to the gear.

These and other preferred embodiments of the present invention will be described in more detail below.

### BRIEF DESCRIPTION OF THE DRAWINGS

FIG. 1 shows a perspective view of a valve assembly, in accordance with certain preferred embodiments of the present invention.

FIG. 2A shows an end elevational view of the valve assembly of FIG. 1.

FIG. 2B shows a side elevational view of the valve assembly of FIG. 1.

FIG. 3 shows a cross-sectional view of the valve assembly shown in FIG. 2A taken along line A-A thereof.

FIG. 4 shows a cross-sectional view of the valve assembly shown in FIG. 2A taken along line C-C thereof.

FIG. 5A shows an interior face of a flange for a valve assembly, in accordance with certain preferred embodiments of the present invention.

FIG. 5B shows a cross-sectional view of the flange of FIG. 5A taken along line A-A thereof.

FIG. 5C shows a cross-sectional view of the flange of FIG. 5A taken along line B-B thereof.

FIG. 5D shows an exterior face of the flange shown in FIG. 5A.

FIG. 6A shows a cross-sectional view of a center housing for a valve assembly, in accordance with certain preferred embodiments of the present invention.

FIG. 6B shows a cross-sectional view of the center housing of FIG. 6A taken along line A-A thereof.

FIG. 6C shows an end view of the center housing shown in FIG. 6A.

FIG. 7A shows a perspective view of a stationary gate for a valve assembly, in accordance with certain preferred embodiments of the present invention.

FIG. 7B shows a front elevational view of the stationary gate shown in FIG. 7B.

FIG. 7C shows a side elevational view of the stationary gate shown in FIGS. 7A and 7B.

FIG. 8A shows a front elevational view of a gear ring for a valve assembly, in accordance with certain preferred embodiments of the present invention.

FIG. 8B shows a cross-sectional view of the gear ring of FIG. 8A taken along line A-A thereof.

FIG. 9A shows a perspective view of a rotatable disc for a valve assembly, in accordance with certain preferred embodiments of the present invention.

FIG. 9B shows a front elevational view of the rotatable disc of FIG. 9A.

FIG. 9C shows a cross-sectional view of the rotatable disc of FIG. 9B taken along line A-A thereof.

FIG. 9D shows a cross-sectional view of the rotatable disc of FIG. 9B taken along line B-B thereof.

FIG. 10A shows a cross-sectional view of the valve assembly of FIG. 1 with a pair of rotatable discs in an open position.

FIG. 10B shows the valve assembly of FIG. 10A with the pair of rotatable discs in a closed position.

FIG. 11 shows another cross-sectional view of the valve assembly shown in FIG. 10A.

FIG. 12A shows a side elevational view of a worm gear drive for the valve assembly shown in FIG. 10A.

FIG. 12B shows an end view of the worm gear drive shown in FIG. 12A.

FIG. 13 shows a rotatable disc for a valve assembly having an asymmetric opening, in accordance with certain preferred embodiments of the present invention.

FIGS. 14A-14F show a valve assembly having a check valve, in accordance with yet another preferred embodiment of the present invention.

### DETAILED DESCRIPTION

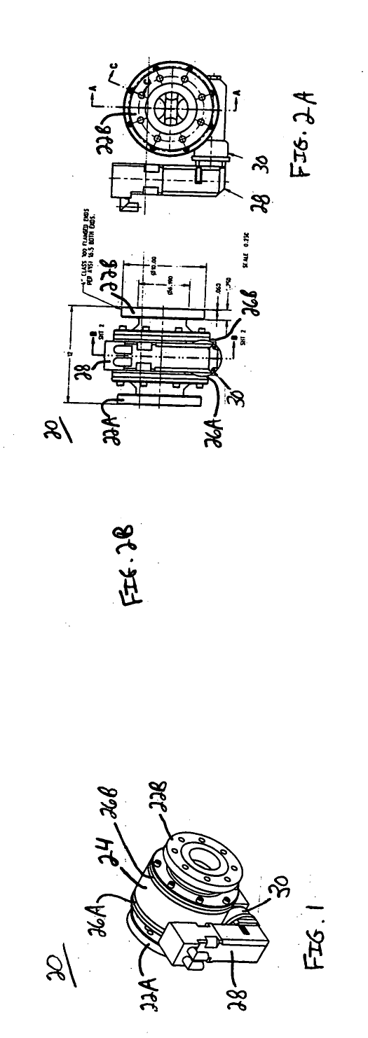

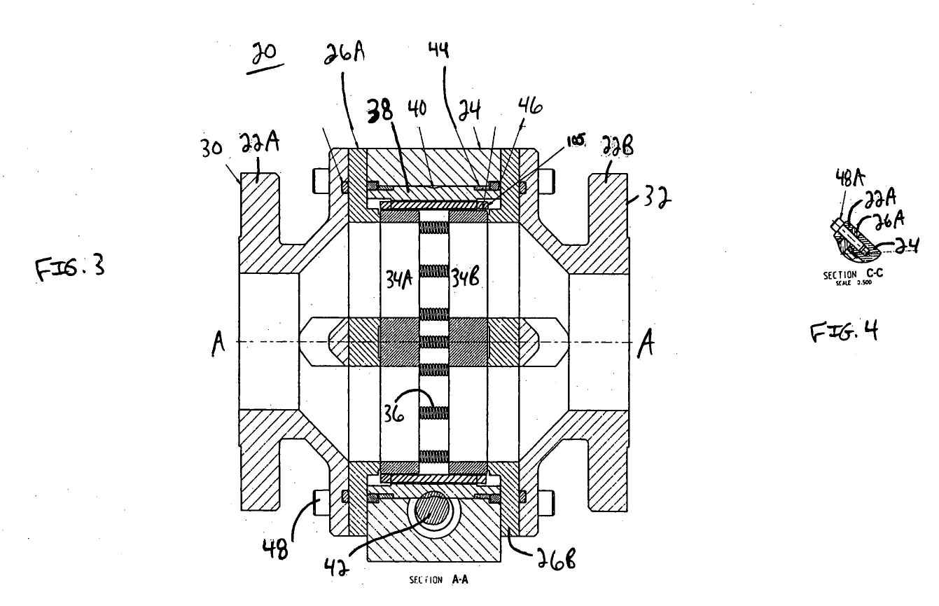

Referring to FIGS. 1-3, in accordance with certain preferred embodiments of the present invention, a valve assembly 20 includes a first flange 22A and a second flange 22B. The valve assembly 20 also includes a center housing section 24 disposed between the two flanges 22A, 22B. The valve assembly 20 also has a first stationary gate 26A positioned between first flange 22A and center housing section 24, and a second stationary gate 26B positioned between second flange 22B and center housing section 24. Valve assembly 20 preferably has a motor/gear box 28 that is coupled with the valve assembly via adapter 30 for moving the valve between open and closed positions.

Referring to FIG. 3, the first flange 26A of valve assembly 20 has an outer face 30 that is adapted to engage piping coupled with the valve assembly. Second flange 26B also has an outer face 32 adapted for engaging piping. The valve assembly includes a pair of rotatable discs 34A, 34B that are biased away from one another by a plurality of springs 36. In certain preferred embodiments, the plurality of springs are evenly spaced from one another between the two rotatable discs 34A, 34B. In other preferred embodiments, however, the springs may be unevenly spaced between the plates 34A, 34B. In other preferred embodiments, the springs 36 may be a single spring or a pair of springs. The pair of springs may be spaced from one another. The two rotatable discs 34A, 34B are coupled with a gear ring 38, the ring gear having gear teeth 40 provided at an outer surface thereof. The gear teeth 40 are adapted to engage threads on a worm drive 42 for selectively rotating the gear ring that, in turn, rotates the rotatable discs 34A, 34B. The rotatable discs 34A, 34B are designed to rotate simultaneously with the gear ring 38, however, the rotatable discs are free to move independently of the gear ring along the axial direction designated A-A. The valve assembly also includes first stationary gate 26A and second stationary gate 26B. Interior faces of the stationary gates 26A, 26B are abutted against opposite ends of center housing 24, with the center housing 24 surrounding the rotatable discs 34A, 34B.

The valve assembly 20 includes a bushing 44 that guides the ring gear 38 disposed within center housing 24. The bushing 44 is preferably made of a material that reduces wear and/or friction between the gear ring 38 and the central housing 24. In other preferred embodiments, the bushing 44 prevents or greatly minimizes engagement of the ring gear 38 and the center housing 24. Valve assembly 20 also includes a seal 46 that provides a fluid-tight seal between ring gear 38 and stationary gates 26A, 26B. The seal 46 also provides a fluid-tight seal between center housing 24 and stationary gates 26A, 26B. The seal 46 prevents lubricant such as oil from leaking externally out of the valve assembly or from leaking internally into the fluid flow path.

In certain preferred embodiments, the rotatable discs are positioned in center housing 24 and biasing springs 36 are positioned between the rotatable discs 34A, 34B. The first and second stationary gates 26AA, 26B are secured over openings at opposite ends of the center housing and the first and second flanges 26A, 26B are secured over the respective stationary gates. The assembly 20 is held together using bolts 48. FIG. 4 shows a bolt 48A holding first flange 22A and first stationary gate 26A to center housing 24.

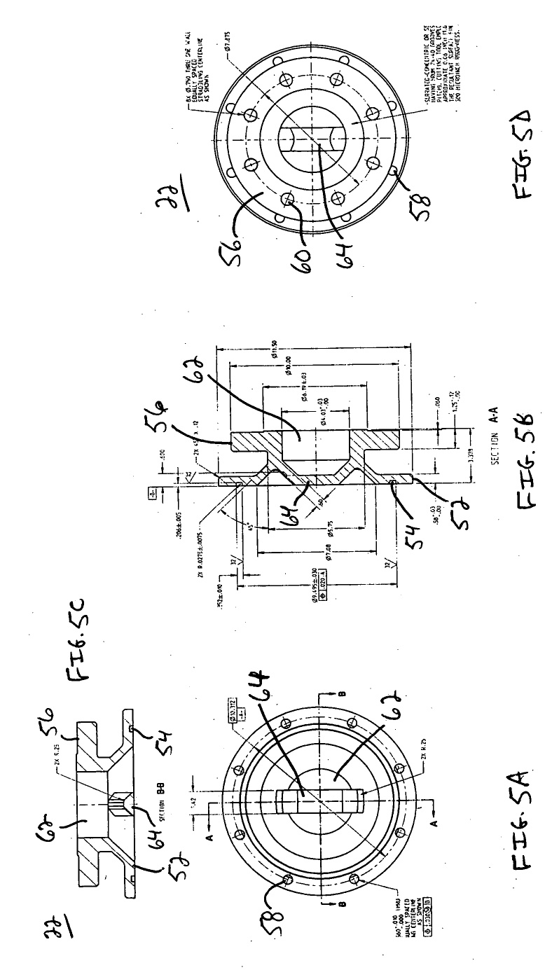

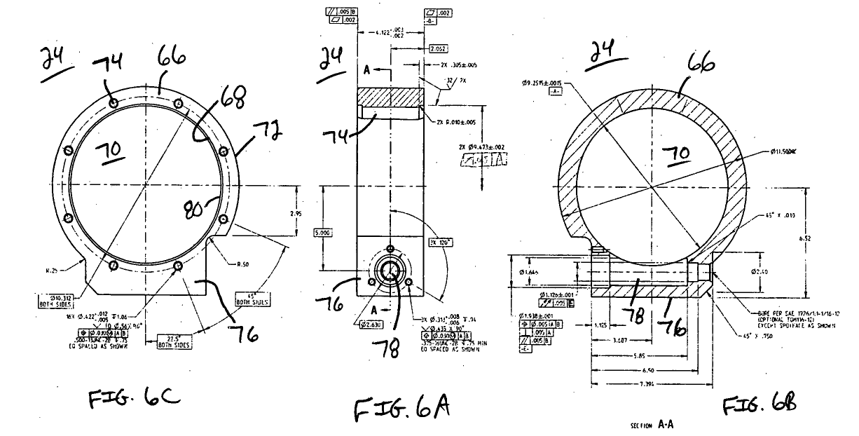

Referring to FIGS. 5A-5D, flange 22 has an interior face 52 having an O-ring groove 54 and an exterior face 56. The interior face 52 has a plurality of openings 58 extending therethrough that are adapted to receive bolts 48 (FIG. 3) for securing the flange to the center housing of the valve assembly. The exterior face 56 of flange 22 also has a plurality of openings 60 used for connecting the flange 22 with piping (not shown). Flange 22 has a central opening 62 that provides a fluid flow inlet for the valve assembly. Flange 22 also has a center support 64 that directs fluid flow into and out of the valve assembly. The center support 64 preferably guides the fluid flow along a path that minimizes turbulent flow and/or cavitation of the fluid. The center support 64 preferably engages an outer face of one of the stationary gates 26 for preventing the gate from bending or warping as fluid flows through the valve (see FIG. 3).

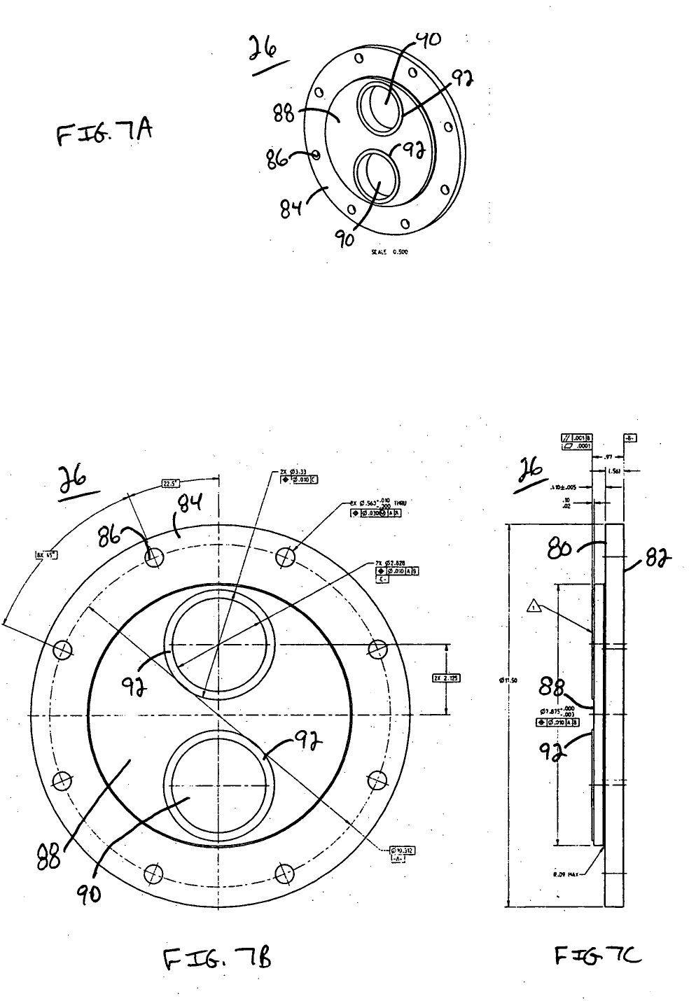

Referring to FIGS. 6A-6C, center housing 24 includes a peripheral wall 66 having an inner face 68 defining a central opening 70 and an exterior face 72. The housing includes a plurality of peripheral openings 74 extending through outer wall 66 adapted to receive securing bolts. Center housing 24 also includes a base 76 that provides a mating interface for mating with the motor/gear box 28 (not shown). The base 76 has a worm gear drive opening 78 for receiving a worm gear drive (not shown). The inner surface 68 of center housing 66 includes a slot 80 adapted to receive the T-shaped seal 46 (FIG. 3).

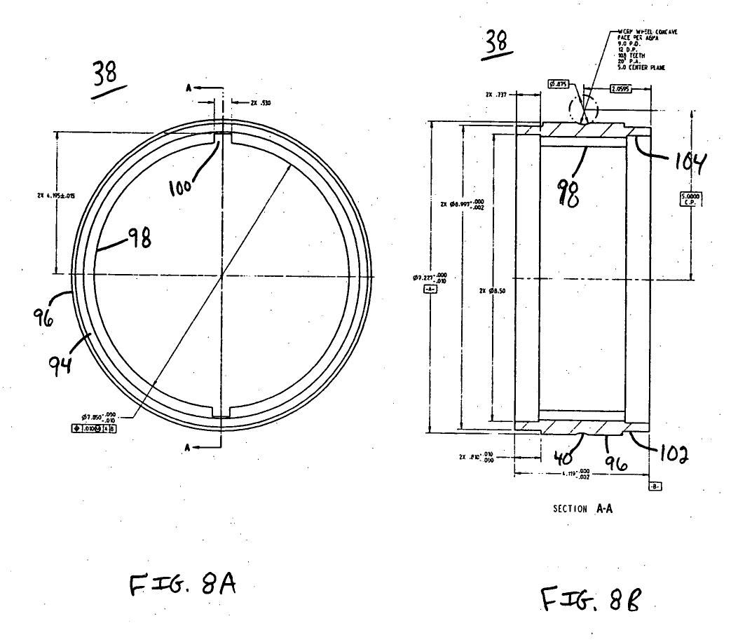

Referring to FIGS. 7A-7C, stationary gate 26 has an inner face 80 that faces one of the rotating discs and an outer face 82 that faces one of the flanges. The stationary gate 26 includes an outer rim 84 having a plurality of bolt openings 86 extending therethrough. The stationary gate 26 includes a central region 88 having a pair of larger fluid openings 90, which are surrounded by a sealing seat 92. Referring to FIG. 7C, sealing seat 92 is raised above the surface of central region 88.

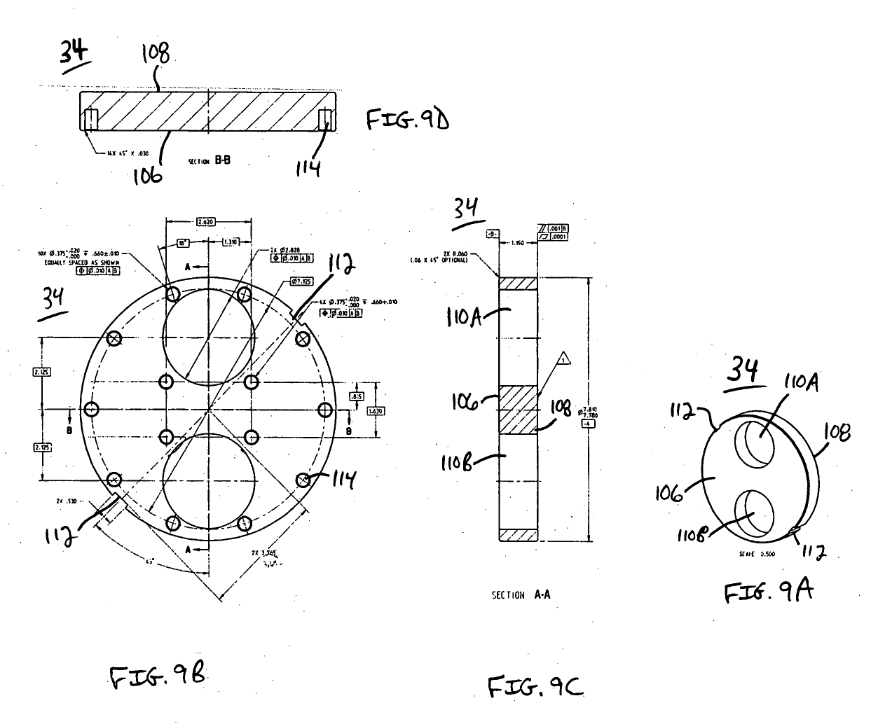

Referring to FIGS. 8A and 8B, gear ring 38 has an outer wall 94 having an outer surface 96 and an inner surface 98. The outer surface 96 of gear ring 94 includes gear teeth 40 adapted to engage external threads on a worm drive (not shown). The inner face 98 includes key slots 100 used for coupling the gear ring 94 with the rotatable discs 34A, 34B (FIG. 3). Referring to FIG. 8B, the exterior surface 96 of wall 94 includes a seal slot 102 for receiving bushing 44 and T-shaped seal 46. The inner surface 98 includes a second seal slot 104 adapted to receive a second seal 105 (FIG. 3).

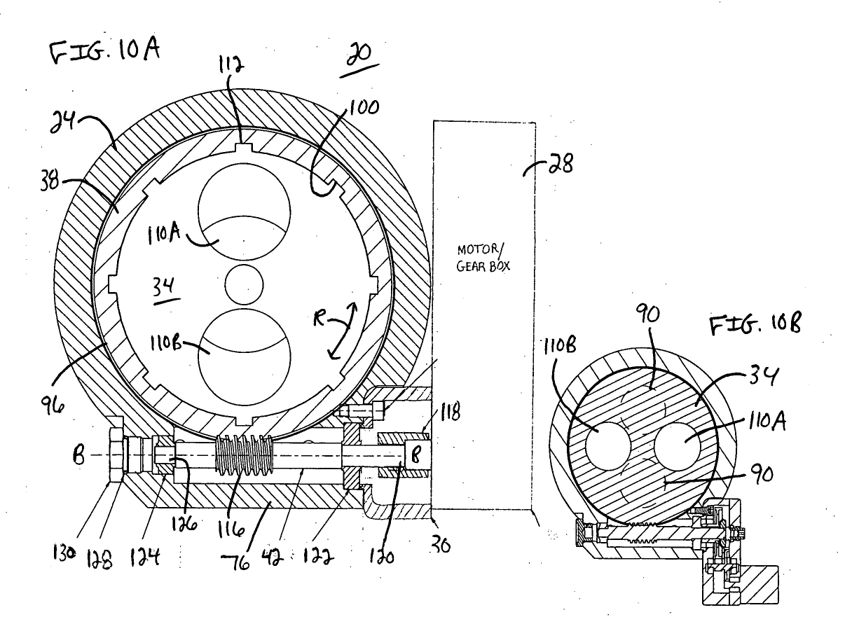

Referring to FIGS. 9A-9D, a rotatable disc 34 has an inner face 106 and an outer face 108. The rotatable disc 34 includes a pair of fluid openings 110A, 110B extending therethrough. Rotatable disc 34 also includes one or more key slots 112 extending between the inner and outer faces 106, 108. The key slots are adapted for connecting the rotatable disc 34 with the ring gear 38 so that the rotatable disc rotates simultaneously with the ring gear, while being free to move in an axial direction relative to the ring gear. Referring to FIG. 9B, the inner face of rotatable disc 34 includes a plurality of blind vias 114 that are adapted to receiving biasing springs 36 (FIG. 3). FIG. 9 shows blind vias 114 extending part ways between inner face 106 and outer face 108 of rotatable disc 34.

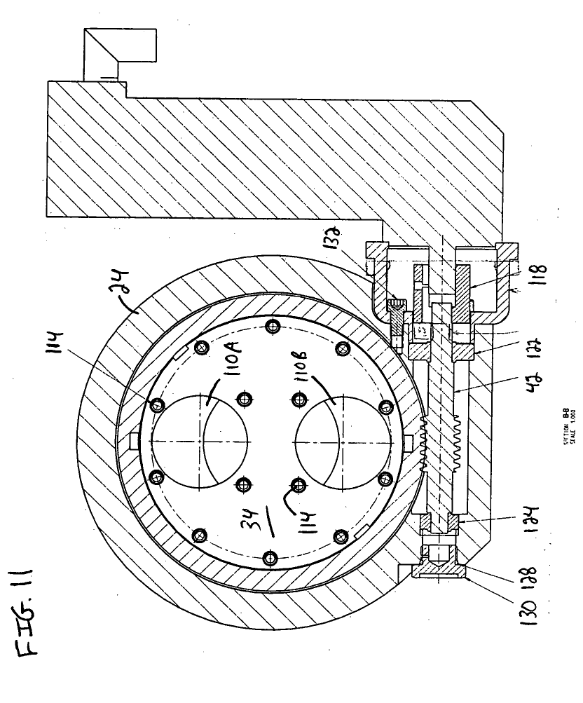

Referring to FIG. 10A, valve assembly 20 includes center housing 24 surrounding gear ring 38 and rotatable disc 34. Gear ring 38 includes key slots 100 adapted for receiving keys 112 at the outer periphery of rotatable disc 34. The engagement of the keys 112 with the key slots 100 ensures that the disc 34 rotates simultaneously with the gear ring, while the disc remains free to remove axially relative to the gear ring. The outer surface 96 of gear ring 38 includes teeth (not shown) that engage threads 116 on worm drive 42. In operation, as the worm drive 42 rotates about its longitudinal axis B-B, the threads 116 engage the gear teeth on the outer surface of ring gear 38 for rotating the ring gear in clock-wise or counter clock-wise directions, as indicated by the arrow “R”. As the ring gear 38 rotates, the rotatable disc 34 rotates simultaneously therewith.

Valve assembly 20 includes an adapted 30 for coupling worm drive 42 with motor/gear box 28. The adapter 30 includes a coupler 118 for coupling motor/gear box 28 and a first end 120 of the worm drive shaft. Adapter 30 also includes a bushing 122 that supports rotation of the first end 120 of worm drive 42. The valve assembly 20 also includes a second bushing 124 that supports rotation of a second end 126 of worm drive 42. The assembly also includes an O-ring seal 128 and a plug 130 for sealing the opening in the base 76 of center housing 24.

In FIG. 10A, the valve assembly 20 is in an open position with the central openings 110A, 110B of rotatable disc in alignment with the openings 90 (FIG. 7A) in the stationary gates 26A, 26B. In FIG. 10B, the rotatable disc 34 has been rotated 90° so that the openings 110A, 110B are not in alignment with the openings 90 of the stationary seat. As a result, the valve assembly is in the closed position so that fluid may not flow therethrough.

FIG. 11 shows a cross-sectional view of the valve assembly shown in FIGS. 1 and 10A. The valve assembly includes rotatable disc 34 having openings 110A, 110B formed therein. The inner face of rotatable disc 34 includes a plurality of blind vias 114 that are spaced from one another. The blind vias 114 are adapted to receive springs 36 (FIG. 3) for biasing the rotating discs 34A, 34B away from one another. The adapter 118 is secured to center housing 24 using bolts or screws 132.

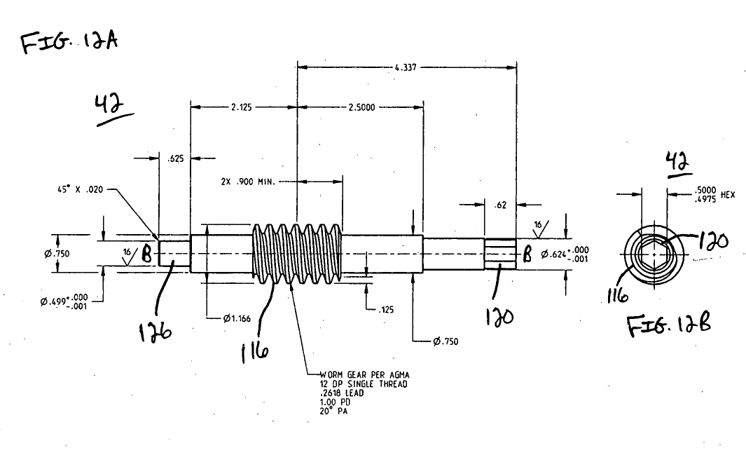

FIGS. 12A and 12B show the worm gear drive 42. Worm gear drive 42 has a first end 120 and a second end 126 remote therefrom. Worm gear drive 42 has a shaft including an outer surface with threads 116 formed thereon. The worm gear drive 42 rotates about a longitudinal shaft B-B.

In operation, the valve assembly 20 is attached to the ends of piping. The first flange 22A is attached to an end of a first pipe and the second flange 22B is attached to the end of a second pipe. The valve is a bi-directional valve that enables fluid to flow through the valve in either direction. Referring to FIG. 3, when fluid is flowing from left to right, the fluid impinges upon first rotatable disc 34A. The force of the fluid separates the first rotatable disc 34A from its engagement with the inner face of first gate 26A. At the same time, the fluid force is transferred through springs 36 to the second rotatable disc 34B for seating the exterior face of the second rotatable disc against the inner face of the second gate 26B. When the fluid is flowing from right to left, the process is reversed with the second rotatable disc 34B being at least partially unseated from its engagement with the second gate 26B and the first rotatable disc 34A being urged against the first gate 26A.

The rotatable discs 34A and 34B are designed to rotate simultaneously between valve open and valve closed positions. The rotatable discs 34A, 34B are preferably coupled with ring gear 38 for simultaneously rotating with ring gear as ring gear is driven by worm drive 42. The key slot/key arrangement described above facilitates simultaneous rotation of the rotatable discs 34A, 34B with the ring gear 38, while enabling the rotatable discs 34A, 34B to move axially along axis A-A relative to the ring gear 38.

Although the present invention is not limited by any particular theory of operation, it is believed that the raised sealing seat 92 (FIGS. 7A-7C) prevents debris from collecting between the outer face of the ceramic discs and the sealing seats 92. If the sealing seats 92 were not raised, then there is a possibility that debris may collect between the outer face of the rotatable disc and the inner face of the gate, which could prevent a proper seal being formed between the downstream rotatable disc and the stationary gate. Thus, the sealing seat 92 is preferably provided to ensure the formation of a proper seal between the rotatable disc and the stationary gate. The raised sealing seat also reduces the contact area between the rotatable discs and the stationary gates to minimize the drive force required to move the unit between open and closed positions. The surface finish on the rotatable discs and the stationary gates may also be modified to minimize the tendency of very flat and smooth surfaces to ring or stick. In certain preferred embodiments, the surface finish of at least one of the rotatable discs and at least one of the stationary gates that enagages the at least one rotatable disc may be dissimilar. The dissimilar finish on the opposing disc/gate has been found to minimize the tendency of the disc/gate to ring or lock together. The tendency of very flat and smooth surfaces to ring is a severe problem that can not be tolerated in environments where valves must be reliably opened and closed when necessary. As a result of the dissimilar finishes on the opposing parts, the rotatable disc of the present invention will be less likely to ring or lock to the gate, with the result that less driving force will be required to move the unit between open and closed positions. In one particular preferred embodiment, the surface finish of the sealing seat is about 5-15 Ra Max and more preferably about 10 Ra Max and the surface finish of the rotatable disc is about 5-15 Ra Max and more preferably about 10 Ra Max, but the lay of the finish between the two is different.

FIG. 13 shows a section of a valve assembly, in accordance with another preferred embodiments of the present invention. The valve assembly includes a stationary plate 26′ having an opening 90′ surrounded by a sealing seat 92′. The valve assembly includes a rotatable disc 34′ having an asymmetrical opening 110′. Although the present invention is not limited by any particular theory of operation, it is believed that providing an asymmetrical opening on either the rotatable disc or the stationary gate will enable an operator to create a variety of flow profiles, which potentially provides a valve user with more precise modulation profiles while using relatively simple positioning controls.

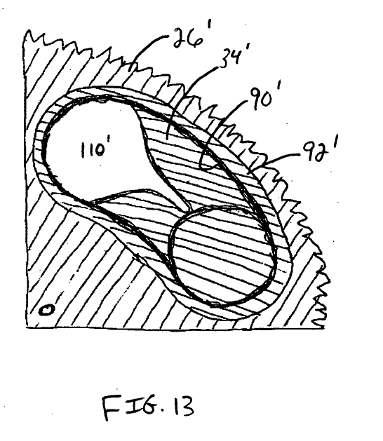

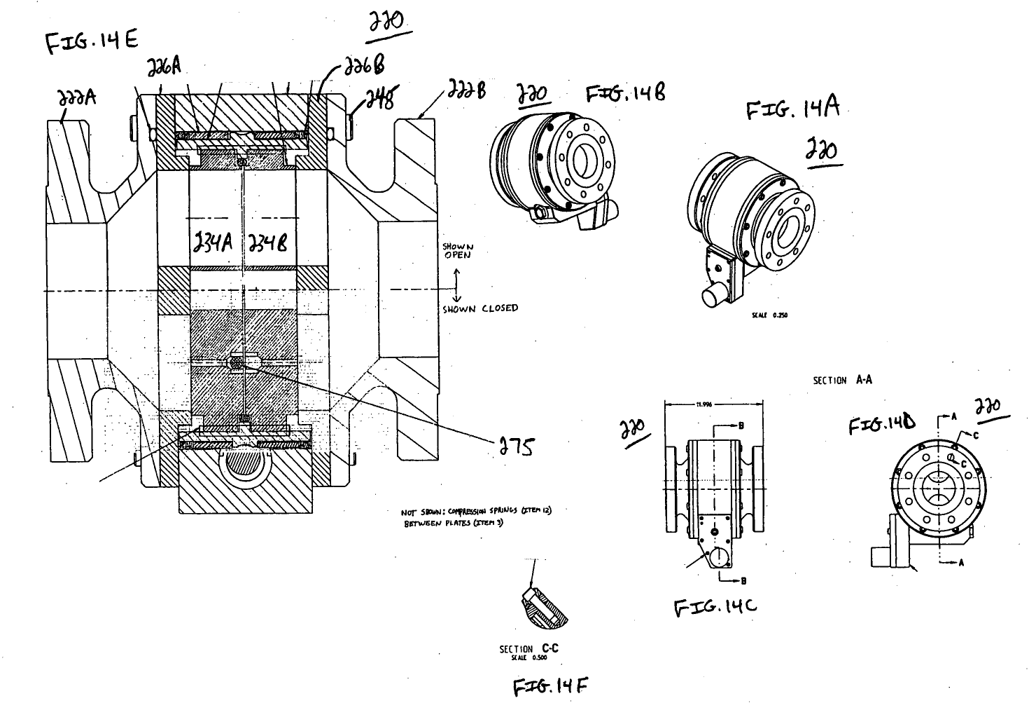

FIGS. 14A-14F show a valve assembly 220, in accordance with yet another preferred embodiment of the present invention. The valve assembly 220 preferably includes first and second rotatable discs 234A, 234B sandwiched between stationary seats 226A, 226B, which in turn are sandwiched between first flange 222A and second flange 222B. The assembly is held together using bolts 248. The rotatable discs 234A, 234B are normally biased away from one another by springs provided between the opposing faces of the rotatable discs. The biasing springs are not shown in the FIGS. 14A-14F. The valve assembly includes a check valve 275 that prevents lift off of the upstream rotatable disc 234 to avoid debris accumulation between the outer face of the upstream rotatable disc and the inner face of the opposing stationary seat 226. For example, when the flow is from right to left in FIG. 14E, the check valve 275 is forced to the left for urging first rotatable plates 234A against first stationary seat 226A. Due to the pressure relief provided by the check valve 275, the second rotatable disc 234B is not forced off its seating engagement with second stationary seat 226B, which prevents debris accumulation between the outer face of disc 234B and the inner face of stationary gate 226B. If the flow direction changes so that the flow is from left to right in FIG. 14E, the check valve 275 moves to the right to perform the opposite function as described above.

In certain preferred embodiments, the present invention utilizes one or more of the preferred embodiments disclosed in commonly assigned U.S. patent application Ser. No. 10/826,545, filed Apr. 16, 2004, the disclosure of which is hereby incorporated by reference herein.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A valve assembly comprising:
a first gate having at least one opening;
a second gate having at least one opening, said second gate being spaced from said first gate;
first and second discs disposed between said first and second gates, each said disc having at least one opening, wherein said discs are coupled together for simultaneously rotating between a valve open and a valve closed position;
a biasing element disposed between said first and second discs for normally urging said discs away from one another and toward opposing inner faces of said first and second gates.

2. The assembly as claimed in claim 1, wherein said first and second gates are stationary and said first and second discs are rotatable relative to said stationary gates.

3. The assembly as claimed in claim 1, wherein the at least one opening of said first gate is in at least partial alignment with the at least one opening of said second gate.

4. The assembly as claimed in claim 1, wherein each said gate includes a sealing seat surrounding said openings of said gates, said sealing seats being raised relative to said inner faces of said gates.

5. The assembly as claimed in claim 4, wherein said sealing seats comprise ceramic.

6. The assembly as claimed in claim 5, wherein said first and second gates comprise ceramic.

7. The assembly as claimed in claim 6, wherein said first and second rotatable discs comprise ceramic.

8. The assembly as claimed in claim 1, wherein said openings of said discs are at least partially aligned with said openings of said gates when said discs are in said valve open position.

9. The assembly as claimed in claim 1, wherein said openings of said discs are not in alignment with said openings of said gates when said discs are in said valve closed position.

10. The assembly as claimed in claim 2, further comprising a gear ring coupled with said discs, wherein rotation of said gear ring drives rotation of said rotatable discs.

11. The assembly as claimed in claim 10, further comprising at least one key slot and at least one key projection for coupling said gear ring and said discs, wherein said discs are free to move axially relative to said gear ring.

12. The assembly as claimed in claim 10, further comprising means for coupling said gear ring to said discs so that said discs rotate simultaneously with said gear ring while remaining free to move axially relative to said gear ring.

13. The assembly as claimed in claim 1, further comprising:
a first flange coupled with said first gate on a first side of said valve assembly and a second flange coupled with said second gate on a second side of said valve assembly.

14. The assembly as claimed in claim 13, wherein each said flange includes at least one opening in communication with said openings of said respective gates.

15. The assembly as claimed in claim 13, wherein each said flange includes a support web adapted to engage one of said gates for providing support for said gate.

16. The assembly as claimed in claim 13, wherein each said flange includes an external coupling interface for coupling piping to said valve assembly.

17. The assembly as claimed in claim 1, further comprising an actuator coupled with said first and second rotatable discs for rotating said discs between the valve open and the valve closed positions.

18. The assembly as claimed in claim 17, wherein said actuator comprises a gear attached to said first and second rotatable discs and a movable drive shaft coupled with said gear.

19. The assembly as claimed in claim 18, wherein said gear has gear teeth and said drive shaft has projections that mesh with said gear teeth.

20. The assembly as claimed in claim 19, wherein said drive shaft is rotatable and has threads.

21. The assembly as claimed in claim 1, wherein inner faces of said rotatable discs have blind vias and ends of said springs are positioned in said blind vias.

22. The assembly as claimed in claim 1, wherein said springs are helical springs.

23. The assembly as claimed in claim 1, further comprising a center housing at least partially surrounding said rotatable discs, said first and second gates being connected with said center housing.

24. A valve assembly comprising:
a center housing having a central opening extending from a first side to a second side of said center housing;
a first gate secured to said first side of said center housing;
a second gate secured to said second side of said center housing;
a pair of rotatable discs disposed in said center housing, each said disc having at least one opening extending therethrough;
a biasing element for urging said rotatable discs away from one another and toward said respective first and second gates;
an actuator coupled with said rotatable discs for selectively rotating said discs.

25. The assembly as claimed in claim 24, wherein said actuator includes means that couple said discs for simultaneous rotation between open and closed positions while enabling said discs to move axially relative to said actuator.

26. The assembly as claimed in claim 25, wherein said actuator comprises a ring gear coupled with said rotating discs and a worms gear coupled with said ring gear.

27. The assembly as claimed in claim 26, wherein said ring gear has at least one key slot and said rotatable discs have at least one projection that fits within said at least one key slot.

28. The assembly as claimed in claim 26, wherein said ring gear has at least one projection and said rotatable discs have at least one key slot that receives said at least one projection of said ring gear.
